(19) United States
(12) Patent Application Publication
(10) Pub. No.: US 2026/0222776 A1
(43) Pub. Date: Jul. 30, 2026

(54) SECURE COMMISSIONING/PAIRING PROCEDURE FOR BATTERY-LESS AND OTHER ENERGY CONSTRAINED DEVICES

(71) Applicant: Silicon Laboratories Inc., Austin, TX (US)

(72) Inventors: Franco Maggi, Hvalstad (NO); Olfert Paulsen, Dragor (DK); Yu-Chieh Huang, Taiwan (TW)

(21) Appl. No.: 19/093,534

(22) Filed: Mar. 28, 2025

Related U.S. Application Data
(60) Provisional application No. 63/750,651, filed on Jan. 28, 2025.

(51) Int. Cl. H04W 4/50; H02J 50/00; H04W 52/02

(52) U.S. Cl. CPC H04W 4/50; H02J 50/001; H04W 52/0251

(57) ABSTRACT

An energy constrained device includes microcontroller and a transceiver to communicate on an RF network. An energy harvesting device harvests energy and an energy storage device stores the harvested energy for use in commissioning on the RF network to allow the energy constrained device to securely communicate on the RF network. The microcontroller performs a plurality of commissioning steps to accomplish the commissioning. Energy harvesting occurs between each of the commissioning steps. In one approach, after each commissioning step the integrated circuit is allowed to power down resulting in a brown out reset. Commissioning information is stored in non-volatile memory prior to powering down. In another approach, the integrated circuit enters a sleep mode between each of the commissioning steps in which machine state is maintained in RAM. The integrated circuit wakes up from the sleep mode after sufficient energy is harvested to complete a next commissioning step.

### CROSS-REFERENCE TO RELATED APPLICATION(S

This application claims benefit of U.S. Provisional Application No. 63/750,651, entitled “Secure Commissioning/Pairing Procedure for Battery-Less and Other Energy Constrained Devices,” naming Franco Maggi, Olfert Paulsen, and Yu-Chieh Huang as inventors, which application was filed January 28, 2025, and which application is incorporated herein by reference.

### BACKGROUND

### FIELD OF THE INVENTION

This disclosure relates to establishing secure wireless communications and more particularly to the establishment of secure communications between energy constrained devices and other devices.

### DESCRIPTION OF THE RELATED ART

Establishing secure communications for Internet of Things (IOT) devices is important for security reasons, particularly as the number of connected IOT devices that communicate over networks increases into the billions. In addition, secure communications are in some cases mandatory, imposed by directives, protocols, or even regulations. While various approaches to establishing secure communications are well known in the art, the problem becomes more challenging for battery-less and other energy constrained devices that lack a user interface that could be used in establishing secure communications, e.g., by entering a unique code associated with the product. Battery-less devices are desirable since they can have a lower cost of ownership since there is no need to replace batteries and can have lower shipping costs. The fact that such devices normally operate in a very low power or power down state for a majority of the time and communication requirements are limited, allows the use of energy harvesting to fulfill energy requirements for normal operation. However, establishing secure communications can require significant power that is greater than the power used during normal operation of the battery-less device.

To address the additional energy needed to establish secure communications current approaches include associating auxiliary batteries or alternate power sources to the otherwise battery-less devices. That of course imposes additional cost on such devices. Other approaches use Out of Band (OOB) techniques to establish secure communications where, e.g., a different network is used to establish a key or where near-field communications (NFC) requiring proximity to the battery-less device is used. An OOB approach can, e.g., use pre-printed numeric or alpha-numeric codes manually registered by the user directly entered on a proxy, gateway, or host device. Some approaches use QR codes accompanying product packaging as part of the process of entering numeric codes. Thus, auxiliary power or OOB approaches burden users with more cumbersome procedures.

Given the energy constraints of battery-less devices, it would be desirable to provide improvements in establishing secure communications that maintain the cost advantages of not having a battery, avoid the use of OOB techniques, and that do not impose significant inconvenience or complexity on the user.

### SUMMARY

In an embodiment a method for performing a commissioning to establish secure communications for a device on a network includes performing a plurality of commissioning steps to accomplish the commissioning, the commissioning steps being performed between actuations of an energy harvesting operation that harvests energy for the device.

In an embodiment the method includes retrieving information corresponding to a most recently completed commissioning step, after a first commissioning step is completed, and after each commissioning step storing current information related to a current one of the commissioning steps into a non-volatile memory prior to a brown out reset in which the device is deenergized.

The method may include entering a sleep mode rather than a brown out state after completing a commissioning step and maintaining state and harvesting energy during the sleep mode.

In an embodiment an apparatus includes an integrated circuit including a processor, a radio transceiver, and memory. The processor is configured to cause a plurality of commissioning steps to be performed to accomplish a commissioning of a device on a radio frequency (RF) network, with each of the commissioning steps being performed between actuations of an energy harvesting operation.

In an embodiment of the apparatus, the integrated circuit enters a brown out reset in which the integrated circuit is deenergized after each of the commissioning steps and commissioning information is stored in non-volatile memory prior to the brown out reset.

In an embodiment of the apparatus, the memory includes random access memory (RAM) storing commissioning information and between each of the commissioning steps the integrated circuit is configured enter a sleep mode in which machine state is maintained in the RAM.

In an embodiment an energy constrained device includes an integrated circuit including a microcontroller and a radio frequency transceiver to communicate on a radio frequency (RF) network. The device includes an energy harvesting device and an energy storage device coupled to the energy harvesting device. The energy storage device stores energy harvested by the energy harvesting device and supplies power to the integrated circuit. The microcontroller is configured to cause a plurality of commissioning steps to be performed to accomplish a commissioning on the RF network to allow the energy constrained device to securely communicate on the RF network. Energy harvesting occurs between each of the commissioning steps to obtain sufficient energy to allow another commissioning step to be performed.

### BRIEF DESCRIPTION OF THE DRAWINGS

The present invention may be better understood, and its numerous objects, features, and advantages made apparent to those skilled in the art by referencing the accompanying drawings.

FIG. 1 illustrates a prior art secure commissioning flow for battery powered devices.

FIG. 2A illustrates a high-level block diagram of an embodiment of a battery-less device.

FIG. 2B illustrates a high-level block diagram of an embodiment of a battery-less device with a kinetic energy harvester.

FIG. 3 illustrates a flow diagram for an embodiment for bi-directional commissioning for a battery-less wireless device using intermittent device operation.

FIG. 4 illustrates the application activity, energy generation activity, and energy availability for the embodiment illustrated in FIG. 3.

FIG. 5 illustrates an embodiment in which a check is made on energy availability to see if another commissioning step can be executed.

FIG. 6 illustrates another embodiment in which the green power device (GPD) periodically sleeps during the commissioning while retaining data in RAM, gets recharged during the sleep modes, and wakes to complete another commissioning step.

FIG. 7 illustrates the pattern of operation for the commissioning process in which the device enters a sleep mode between each commissioning step, is recharged during the sleep mode, awakens after the sleep mode and completes the next commissioning step.

The use of the same reference symbols in different drawings indicates similar or identical items.

### DETAILED DESCRIPTION

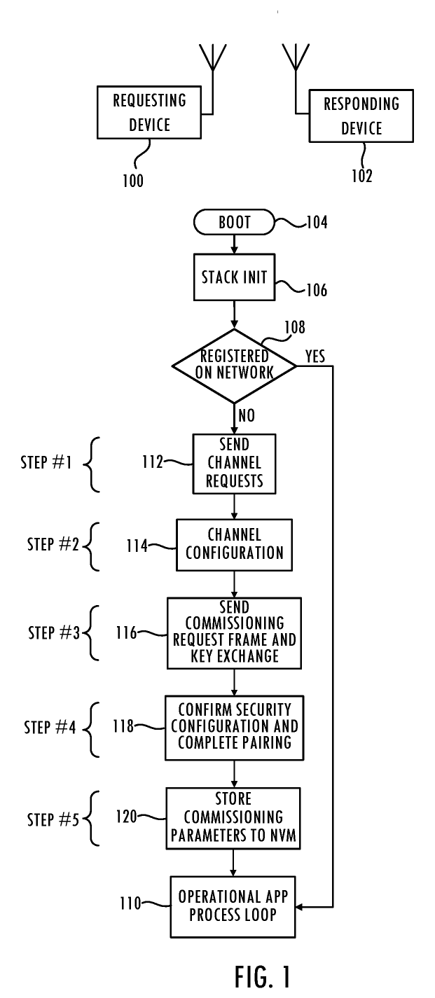

Embodiments described herein provide for two way communication to establish secure communications between devices that have restricted power budgets and intermittent operation and devices that are not energy constrained. Embodiments can also be used to establish secure communications between devices where both devices have restricted power budgets. Energy constrained devices include, e.g., battery-less systems that are normally de-energized (powered-off) when not in use. While the term “battery-less” devices is used for convenience, it is understood that embodiments described herein apply to energy constrained devices including battery-less devices. Thus, e.g., a device may have a small battery or other energy storage device that does not have sufficient capacity to supply enough energy during commissioning to complete a traditional commissioning process shown, e.g., in FIG. 1. Using embodiments described herein allows a device to establish secure communications with another device, thereby allowing the device to join a wireless network. The establishment of secure communications is also referred to herein as commissioning or pairing. The embodiments described herein allow users to pair their devices without requiring cumbersome Out Of Band (OOB) methods or auxiliary energy sources. The approaches described herein utilize software operating on a microcontroller or system on a chip (SoC) on the device to coordinate pairing with simple user actions. The SoC may include a microcontroller, and analog and digital peripherals to support the device application and a radio for RF communications. The energy constrained device being paired can be, e.g., a green power device (GPD) such as a connected switch or another device used in a wide variety of IOT or other applications. One embodiment uses Zigbee Green Power (ZGP) secure commissioning for green power devices but the approaches described herein are applicable to other protocols using bidirectional pairing or commissioning.

FIG. 1 illustrates the flow associated with a prior art commissioning operation that establishes secure communication between the joining device (the device) 100 and the commissioner device102 over a radio frequency (RF) network, which can be a host device or gateway. In an embodiment using the ZigBee Green Power protocol, device 100 is a green power device, 104 is a proxy device. While only two devices are shown, in embodiments the device 100 communicates over a mesh network having more than two devices. The flow diagram represents steps of the initiator device 100. The operation in FIG. 1 assumes the initiator is a device that is battery powered or has auxiliary power to support the commissioning operation. The microcontroller boots at 104 and initializes its software stack at 106. At 108 the device determines if it is registered on the network. If so, the device enters an operational loop at 110 and performs the operations suitable for the application such as sensing a parameter associated with the device and reporting the parameter or other device status over the network.

If the device determines in 108 that it is not registered on the network, the device starts a commissioning or pairing sequence. In step 112 the device sends out requests on various RF channels. When a responder responds to one of the requests on one of the channels, channel configuration takes place in 114 for the particular channel. Channel configuration sets the various transmit and receive parameters associated with the operating channel to be used by the joining device (requester 100) and the commissioner device (responder 102). Channel configuration information is sent by the responder(102) and includes the operating channel of the responder since the operating channel is not know by the requester(100). Channel configuration is of course highly protocol dependent and different protocols and PHYs will establish different configurations. Once the configuration information is received by the requester, the requester then configures the transmit and receive parameters to communicate further with the responder. Once the channel is configured the initiator sends a commissioning request and key exchange takes place in 116. The device confirm security configurations and completes the pairing in 118. In 120 the device stores the commissioning parameters to non-volatile memory (NVM) and enters the operational loop at 110 with the device being securely on the network.

While the commissioning steps shown in FIG. 1 can be readily executed by a device with adequate power being supplied from a battery or other auxiliary power source, a battery-less device would not have the power to perform the commissioning operation shown in FIG. 1.

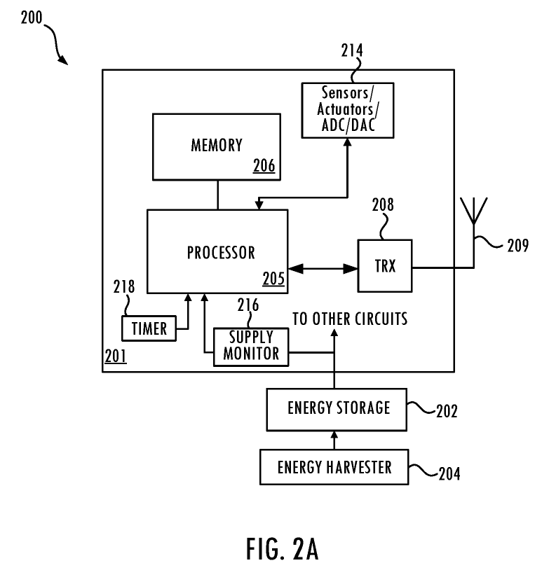

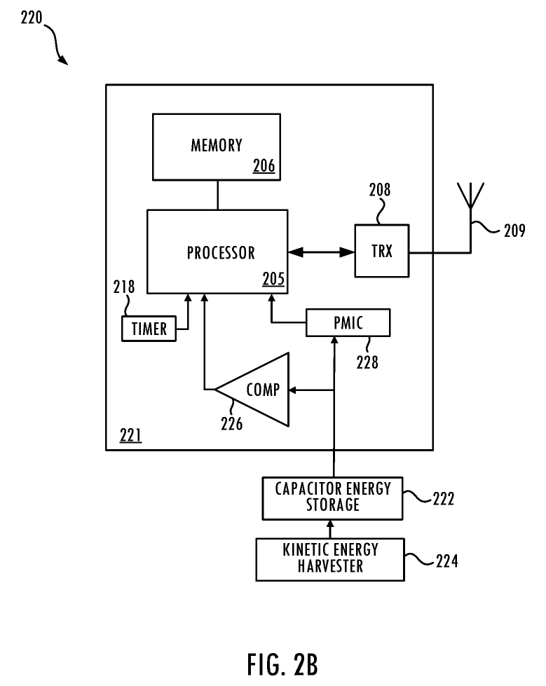

FIG. 2A illustrates a high level block diagram of a battery-less device 200 that uses energy harvesting to supply the necessary power for circuit operations. The battery-less device 200 includes integrated circuit 201, an energy storage device 202, and an energy harvester 204. In an embodiment the energy storage device 202 is a capacitor but other types of energy storage devices can be used. In an embodiment the device 200 is a Zigbee green power device (GPD) such as a connected switch and the energy harvester 204 is an inductor based kinetic energy harvester . The inductor based energy harvester generates a pulse of current that is induced every time the switch is activated through, e.g., pushing on a button or sliding a portion of the switch. Many other types of energy harvesters can be used including an energy harvester with “pulsed” functionality that generates a pulse of current when activated. The energy storage device 202 stores the harvested energy for use by the integrated circuit 201. The integrated circuit may be a microcontroller unit (MCU) or System on Chip (SoC) that includes at least one processor 205 and associated memory 206. The processor 205 executes instructions stored in the memory 206. The memory 206 includes memory for user applications and other software components for functionality required by the system including software executed by the processor to accomplish commissioning steps. In addition, the memory stores commissioning information during the commissioning process as described further herein. The memory 206 includes, e.g., required combinations of static random access memory (SRAM), non-volatile memory (NVM), and/or dynamic RAM according to the particular application in which the integrated circuit operates. In an embodiment, the system includes a radio with a wireless transceiver (TRX) 208 that includes circuits to communicate over a network using antenna 209. The TRX 208 uses one or more wireless protocols such as Wi-Fi®, Bluetooth®, Zigbee™, Zigbee Green Power, or other short range or longer range wireless protocols. The Zigbee Green Power protocol provides optimized message traffic for ultra-low-power devices such as battery-less devices.

In an embodiment, the integrated circuit 201 includes sensors/actuators 214 and analog to digital converters (ADC) and/or digital to analog converter (DAC) circuits to convert sensed data into digital information that can be used by the processor 205 and/or transmitted as needed or to convert commands received by TRX 208 to take an action, e.g., turn on/off home equipment. In an embodiment the integrated circuit 201 performs applications used in Internet of Things (IoT) devices, e.g., home applications such as appliances, lighting control, remote sensing such as water meters, automotive applications, and retail applications. While a kinetic energy harvester is shown in the embodiment illustrated in FIG. 2A, in other embodiments the energy harvesting can be radio frequency (RF) based energy harvesting, thermal, light, or any other energy harvesting mechanisms (or combination of energy harvesting mechanisms) available in the system environment. In an RF based energy harvesting approach, RF energy from RF transmissions from other radios is converted into energy used to charge the capacitor energy storage 202. In an embodiment, the supply monitor 216 samples the energy storage and supplies an indication of how much energy remains in energy storage 202. In an embodiment, an analog to digital converter (ADC) supplies a voltage value to the processor as the indication of remaining energy. The voltage value can be used to determine how much power is left to perform certain operations as further described herein. Of course, other approaches to monitoring energy can be used. For example, an embodiment uses a comparator to compare the voltage in the energy storage to a reference voltage and supply the compare result to the processor. Note that circuitry (e.g., a voltage regulator) to regulate power from the stored energy in the energy storage 202 and gate power (i.e. turn on and off for sleep/wake modes) is not shown to simplify the figure.

FIG. 2B illustrates an embodiment of a battery-less device 220 that includes components 205, 206, 208, 209 and 218 that are described in relation to FIG. 2A. The embodiment illustrated in FIG. 2B includes a capacitor energy storage 222 as the energy storage device and a kinetic harvester 224 as the energy harvester. A comparator 226 compares the voltage of the capacitor energy storage 222 to a threshold value and supplies that indication to the processor 205. In addition a power management (PMIC) device 228 manages power for the devices shown in FIG. 2B, which includes gating power and turning off clocks when appropriate to reduce power consumption. Note that the compare function of comparator 226 may be incorporated into PMIC 228. The various components within block 221 or a subset thereof may constitute an SoC.

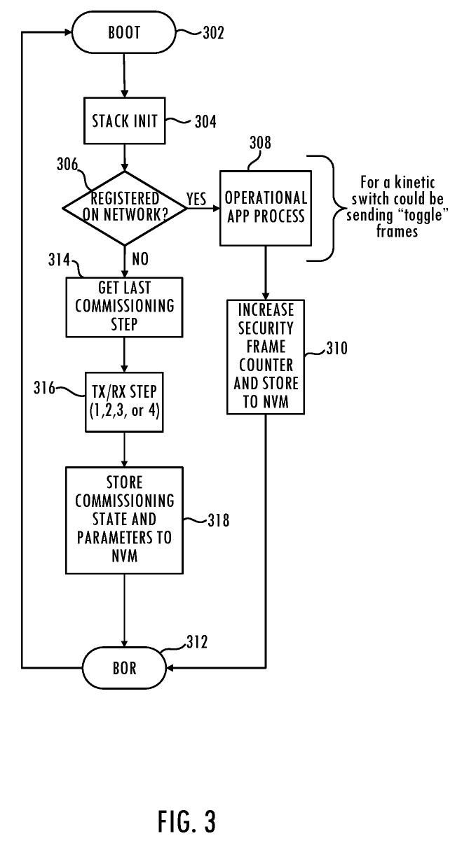

FIG. 3 illustrates an embodiment of a flow diagram for two way network commissioning for a battery-less wireless device that establishes secure communications with another device. Two way communication is usually required for secure network commissioning or pairing of devices. The pairing involves exchange of keys and writing to a non-volatile memory (NVM). Both turning on a receiver and writing NVM are tasks that can require amounts of energy above the energy required for normal operation. Providing that extra energy required during commissioning would require designing the energy harvester and energy storage to have an unnecessary high degree of capability that would be unused during normal operation. Rather than incur the cost for over-designing the device, the flow diagram of FIG. 3 illustrates an intermittent approach for secure Zigbee green power (ZGP) commissioning executed by a green power device that recognizes the limitations associated with battery-less devices and avoids the use of auxiliary power or OOB approaches. FIG. 3 illustrates an intermittent commissioning flow, where a battery-less device, for example a GPD kinetic switch, is power cycled until the commissioning is completed. Such an approach requires an energy budget that supports NVM writing at the end of each commissioning step. The commissioning is performed with discrete steps with energy being harvested between each step to generate a sufficient amount of energy to complete another step and store the results of the step in NVM.

Still referring to FIG. 3, at 302, the device boots and performs a software stack initialization at 304. The device performing the flow of FIG. 3 is, e.g., the device 200 illustrated in FIG. 2A. In 306 the device determines if the device is registered on the network. If so, the device proceeds to the operational application process block 308 and performs the operations suitable for the application. In 310 the device increases the security frame counter to ensure encrypted communications are varied to maintain security and stores the result to NVM. After the supply voltage drops below a threshold voltage, the device goes into a brown out reset (BOR) and returns to a boot at 302 when the power exceeds the operation threshold by collecting the power from the energy harvester. The supply voltage dropping below the threshold results in the device being de-energized as the device is not able to operate with the supply voltage lower than the threshold. During the brown out reset the device enters a state that does not allow the device to retain machine state, and begins a boot operation when the available supply voltage is above the threshold for operation.

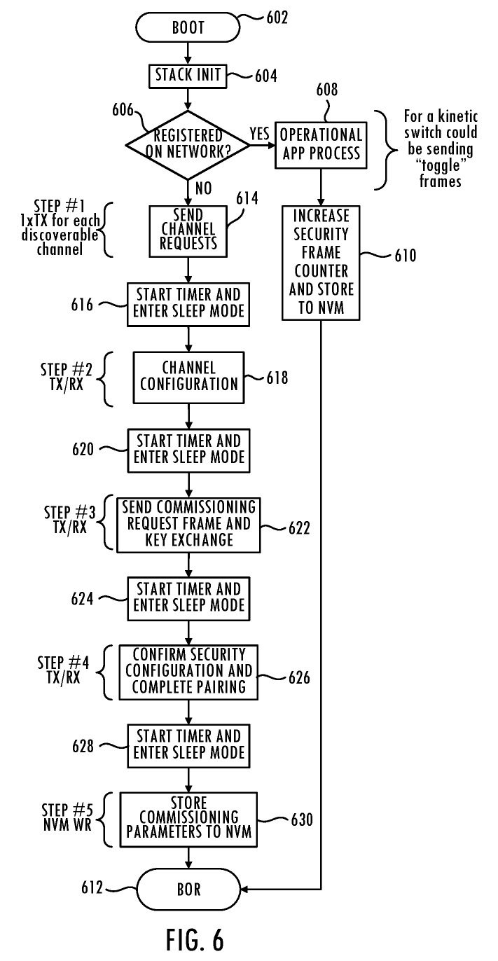

If the device determines in 306 that it is not registered on the network, the device retrieves the last commissioning step from NVM in 314. If this is the first step, the NVM indicates that no steps have been completed. In 316 the device performs one of the four commissioning steps (see the steps identified in FIGS. 1 and 6). After performing the next step, the device stores the commissioning state and parameters to NVM in 318 so the device knows where to pick up the commissioning operation after the next boot. After storing, the device enters BOR 312 when the supply voltage drops below a minimum threshold voltage needed for operation. The steps 302, 304, 306, 314, 316, and 318 are repeated until the commissioning is complete (all four steps completed). After registering on the network, the check in 306 after a boot takes the device to operational application processes in 308.

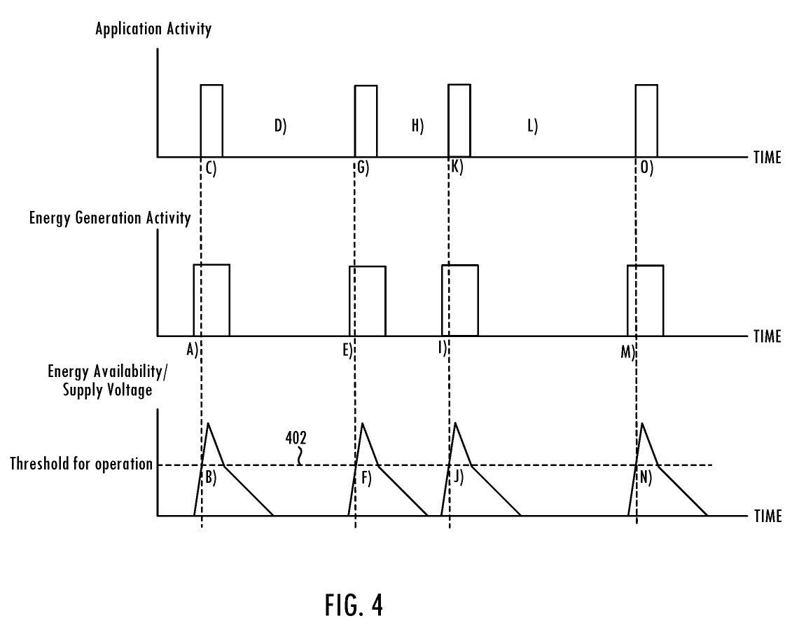

After the BOR takes place, the energy harvested has to be sufficient to allow the boot, necessary transmit (TX) and receive (RX) operations, and an NVM store with timing imposed by the specific protocol, which can pose further burdens on the energy budget of each cycle. FIG. 4 illustrates the application activity, energy generation activity, and energy availability for the embodiment illustrated in FIG. 3. At (A) the energy harvester is activated, e.g., the user activates the switch. A user can activate a kinetic energy harvester by causing motion of the device, e.g., by pushing a button. At (B) the energy/supply crosses the threshold for operation 402 allowing the application, here the flow diagram of FIG. 3, to start executing. At (C) the application starts, completes the first commission step, and saves the result to NVM. The application becomes depleted of energy when the available energy (supply voltage) crosses below the threshold for operation resulting in a BOR. At (E) the user activates the energy harvester (assuming, e.g., a GPD switch) and at (F) the energy/supply becomes high enough (above the threshold for operation) for the application to start executing and at (G) the application starts, reads the commissioning state from NVM, performs commissioning step #2, and stores the new state to NVM. The application becomes depleted of energy when the supply voltage crosses below the threshold for operation resulting in a BOR. At (I) the energy harvester is activated and at (J) the energy/supply becomes high enough for the application to start executing. At (K) the application starts, reads the commissioning state from NVM, continues the commissioning process by performing commissioning step #3, and stores the new state to NVM. The application becomes depleted of energy when the supply voltage crosses below the threshold for operation resulting in a BOR. At (M) the energy harvester is activated and at (N) the energy/supply becomes high enough for the application to start executing. At (O) the application starts, reads the commissioning state from NVM, continues the commissioning process by performing commissioning step #4, and stores the new state to NVM, thus completing the commissioning and successfully registering the device on the network. Because the device reboots every time and reads from NVM, there are no particular timing requirements, apart from a commissioning timeout determined by the commissioning protocol. The burden on the user, assuming a GPD switch, is to activate the switch enough times to complete the commissioning steps before a commissioning timeout. Thus, the energy harvesting and execution of the steps can be considered to be asynchronous. That means, as illustrated in FIG. 4, that the time between activations of the energy harvester at (E) and (I) can be different than the time between activations of the energy harvester at (I) and (M). Note that in other embodiments, where the energy harvesting is passive, e.g., thermal, light, or RF, the user may not need to take any actions to cause the energy harvester to operate.

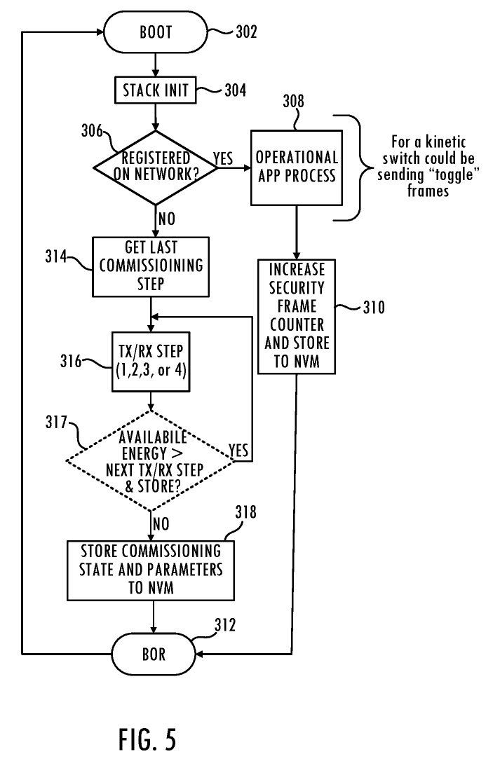

Referring to FIG. 5, an additional optional step is added to the flow shown in FIG. 3. Specifically, after the application executes one of the commissioning steps in 316, the device checks in 317 if there is sufficient energy availability to execute another commissioning step and then save the commissioning state to NVM. If so, then the flow returns to execute another TX/RX step in 316 before storing to NVM. Note that the supply monitor 216 (FIG. 2A) may provide the processor 205 with an indication of the amount of energy (state of charge) stored in the energy storage device 202, e.g., as a voltage level. Note also that the number of steps shown as four can vary depending on the particular commissioning required by the protocol being used, the energy harvesting capability, and the energy storage capability of the joining device. Thus, where needed, the commissioning operation can be divided into more steps or fewer steps according to system needs and the particular commissioning operation being performed.

FIG. 6 illustrates a flow diagram for another embodiment where more restrictive power budgets do not allow NVM writing at each step. Instead, the GPD periodically enters a low energy mode (referred to herein as sleep mode) between commissioning steps and wakes to complete each step. The approach illustrated in FIG. 6 is considered synchronous because for a kinetic switch it requires that the user operates the switch within time frames that are imposed by the sleep timer as described further herein.

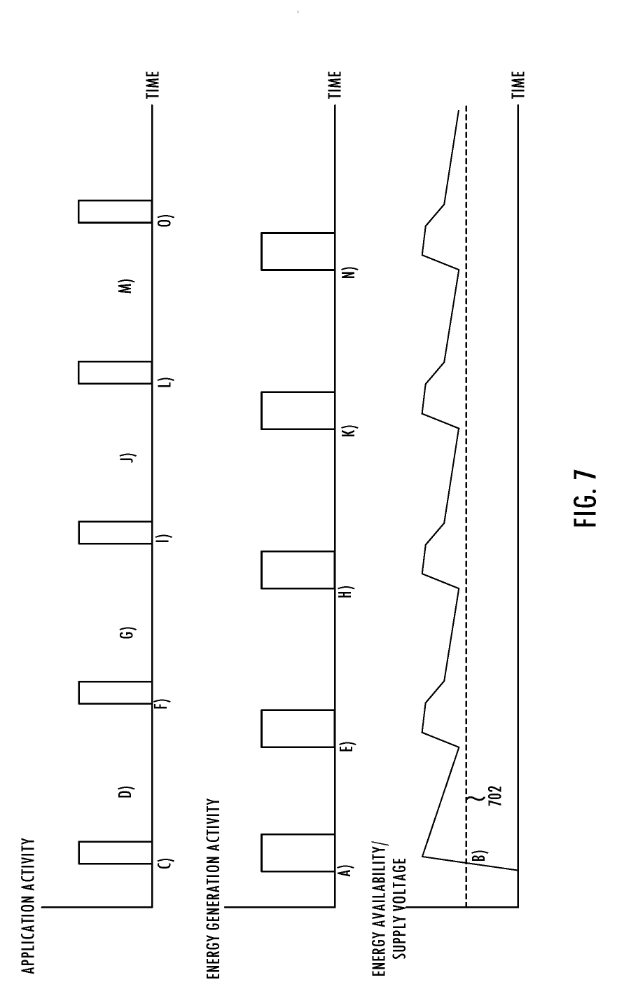

The embodiment illustrated in FIG. 6 applies to GPDs that are small electromechanical systems that are normally in a de-energized state, and once energized by a specific event, or activation cycle, the amount of energy temporarily stored is not sufficient to sustain boot, stack initialization and storing data to NVM at each commissioning step before the system enters a brown-out state and operation is unpredictably disrupted. That is in contrast to GPDs that utilize the embodiment of FIG. 3. For the embodiment illustrated in FIG. 6, the periodic low energy mode (sleep mode) allows the energy harvester to recharge the energy storage device before performing a next step. The energy storage device 202 (see FIG. 2A) retains sufficient energy during the sleep mode for RAM retention to store data and to maintain machine state. As much of the integrated circuit 201 as possible is powered down during the sleep mode. Those parts of the integrated circuit necessary to maintain machine state and RAM retention and to wake up from the sleep mode periodically, remain powered. Thus, in the low energy mode (sleep mode) peripherals and clocks are shut down while retaining RAM data and machine state. Note that the energy consumed to maintain state and for RAM retention can be less than the energy consumed for an NVM write, hence, NVM is not written during commissioning. The sleep timer needs to be programmed based on the energy storage and energy harvesting capabilities. In the case of a kinetic switch, which generates induced current pulses at every activation, the user is required to repeatedly actuate the switch to sustain the pairing process. Assuming that one activation is enough to support one commissioning step, the time period allowable between activations must be shorter than the length of the sleep periods. Otherwise, the device will enter a brown out state and lose data in the RAM and process state will be lost. Process state refers to a more specific part of the machine state and includes, e.g., the step count that indicates which commissioning step the process has completed. For example, if the sleep mode lasts for 1 second and if harvesting does not start before 1 second that risks occurrence of a brown out reset and loss of state. Thus, the user will need to actuate the switch four times in total (assuming four commissioning steps), one time for each commissioning step, and the actuation has to occur during the sleep mode so that there is sufficient power for the device to wake up and the commissioning process to continue and complete the next commissioning step. Note that multiple activations within a second will not be harmful. Thus, the user can be told to repeatedly actuate the switch for a period of 5 seconds as fast as possible to complete the commissioning process. That provides a simple way for the commissioning to be completed. Thereafter the commissioning is completed and parameters stored in NVM. Note that if the user fails to actuate the switch within one second for the three steps following the first (see E, H, K of FIG. 7), the device enters a BOR and starts at BOOT again when sufficient power is available. Thus, although the commissioning is not complete, the device simply retries the commissioning since it is not registered on the network. However, a BOR during storing the commissioning (step #5) can cause significant errors as erroneous data could be stored and thus a BOR during step #5 is best avoided. The repeated activations of the switch generate enough energy to perform all the consecutive steps of commissioning without losing the information temporarily stored in the RAM and without consuming energy to boot and initialize the stack each time as required by the embodiment of FIG. 3.

FIG. 6 illustrates a flow diagram illustrating the use of sleep modes during commissioning. The device boots at 602 and performs a software stack initialization at 604. The device performing the flow of FIG. 6 is, e.g., the device 200 illustrated in FIG. 2A. In an embodiment the device is a GPD such as a switch with a kinetic energy harvester. In 606 the device determines if the device is registered on the network. If so, the device proceeds to the operational application process block 608 and performs the operations suitable for the application. In an embodiment the device is a kinetic switch that sends “toggle” frames during operation. A toggle frame tells the receiver, e.g., a light bulb, to toggle its state. If the receiver is on, it should toggle to off, if the receiver is off, it should toggle to on. In 610 the device increases the security frame counter to ensure encrypted communications are varied to maintain security and the device stores the result to NVM. After the supply voltage drops below a threshold voltage, the device enters a brown out reset (BOR) at 612 and returns to a boot at 602 when there is sufficient power.

If the device determines in 606 that the device is not registered on the network, in 614, the device sends channel requests (commissioning step #1). That step involves turning on the transmitter and transmitting on each discoverable channel. Note that in embodiments, the receiver is not yet turned on to save power. After completing the channel requests, the device starts a timer (e.g., timer 218 in FIG. 2A) and enters a sleep mode. During the sleep mode, the device retains RAM, machine (or process) state, and keeps the timer running and the energy harvester is operating to recharge the energy storage device 202. When the sleep mode ends, e.g., after 1 second, the device performs commissioning step #2 (channel configuration) at 618. For the device, the commissioning step includes turning on the receiver, if needed, receiving configuration information from a responding device, and configuring the device based on received configuration information. The length of the sleep mode depends on how long the device can retain RAM and machine and process state, which in turn depends on the energy storage capability of the device and the energy consumption during the sleep mode. In addition the recharge speed of the energy harvester is also a relevant consideration. If process state is lost, the commissioning process no longer knows what step should be executed next. When step #2 is completed in 618 the device starts a sleep timer and enters the sleep mode at 620. During the sleep mode, the device retains RAM, machine and process state, and keeps the timer running. When the sleep mode ends, e.g., after 1 second, the device performs commissioning step #3 (send commission request frame and perform key exchange) at 622. When step #3 is completed in 622 the device starts the sleep timer and enters the sleep mode at 624. During the sleep mode, the device retains RAM, machine and process state, and keeps the timer running. When the sleep mode ends, e.g., after 1 second, the device performs commissioning step #4 (confirm security configuration and complete pairing) at 626. When step #4 is completed in 626 the device starts the sleep timer and enters the sleep mode at 628. During the sleep mode, the device retains RAM, machine state, and keeps the timer running. When the sleep mode ends, e.g., after 1 second, the device performs commissioning step #5 in 630 (store commissioning parameters to NVM). The device enters BOR 612 when available energy drops below a threshold. The device will boot when available energy is above the required threshold. The flow illustrated in FIG. 6 can be considered a synchronous charge pumping for the energy storage device and secure commissioning flow.

FIG. 7 illustrates the pattern of operation for pulses of energy supplied during the commissioning process while the device enters a sleep mode between each commissioning step. At (A) the energy harvester is activated, e.g., by a user activating the kinetic switch. At (B), the energy availability crosses above the threshold for operation and the energy has become high enough for the application to start executing. At (C) the application starts commissioning process step #1. Energy availability may be determined by the supply voltage crossing above a voltage threshold 702 that indicates the threshold for operation. In an embodiment the supply monitor 216 is used to allow the processor 205 to compare the digital representation of the supply voltage (or other indication of remaining energy) to a threshold stored in RAM or NVM. In an embodiment a comparator compares the supply voltage to the threshold as shown in FIG. 2B. The compare function may also be performed as part of the power management function. At (D) the device is in a sleep mode and the energy harvester harvests energy beginning at (E) responsive to activation of the kinetic switch by a user. New energy is added to the energy storage and the device wakes up when the sleep mode ends and begins the next commissioning step (#2) at (F) and has sufficient energy to complete the step. At (G) the device has returned to the sleep mode after completion of step #2 and energy harvesting begins at (H) responsive to activation of the kinetic switch by a user. New energy is added during the sleep mode and the device wakes up when the sleep mode ends and begins the next commissioning step (#3) at (I) and has sufficient energy to complete the step. The device returns to the sleep mode in (J) after the commissioning step is completed and the energy harvester harvests energy beginning at (K) responsive to activation of the kinetic switch by a user. New energy is added during the sleep mode (J) and the device wakes up when the sleep mode ends and the device performs the next commissioning step (#4) beginning at (L) and has sufficient energy to complete the step in the commissioning process. The device returns to the sleep mode in (M) after the commissioning step #4 is completed and the energy harvester harvests energy beginning at (N) responsive to activation of the kinetic switch by a user. New energy is added during the sleep mode (M) and the device wakes up at the end of the sleep mode and performs the final commissioning step (#5) beginning at (O) with sufficient energy to complete the commissioning step. After the commissioning step #5 is completed, the commissioning is complete and the device has been registered on the network. While not discussed explicitly, commissioning allows joining a network, which is typical of Zigbee, ZGP, or other protocols involving distributed networks.

While the embodiments of FIGS. 6 and 7 can require a user to activate the energy harvesting, in other embodiments, the energy harvesting is passive and the user needs to take no action. Energy harvesting continues while the application is executing and during the sleep mode. In such an embodiment the passive energy harvester harvests enough energy during the sleep mode (and when awake) to allow the device to wake up and the application to complete the next commissioning step after each sleep mode.

Thus, embodiments for network commissioning for battery-less devices and other energy constrained wireless devices have been described. While embodiments described herein have described commissioning steps for Zigbee Green Power (ZGP) devices, the embodiments described herein are applicable to various communication protocols and secure commissioning utilized for such protocols. The description of the invention set forth herein is illustrative and is not intended to limit the scope of the invention as set forth in the following claims. For example, equivalent elements may be substituted for those illustrated and described herein, and certain features may be utilized independently of the use of other features, all as would be apparent to one skilled in the art after having the benefit of this description. Note that the terms “first,” “second,” “third,” and so forth, as used in the claims, unless otherwise clear by context, is to distinguish between different items in the claims and do not otherwise indicate or imply any order in time, location, or quality. Variations and modifications of the embodiments disclosed herein may be made based on the description set forth herein, without departing from the scope of the invention as set forth in the following claims.

What is claimed is:

1. A method for performing a commissioning to establish secure communications for a device on a network comprising:
performing a plurality of commissioning steps to accomplish the commissioning, the commissioning steps being performed between actuations of an energy harvesting operation that harvests energy for the device.

2. The method as recited in claim 1 wherein the network is a wireless network.

3. The method as recited in claim 1 further comprising the device entering a brown out reset after each of the commissioning steps.

4. The method as recited in claim 3 further comprising:
along with each of the commissioning steps,
performing a boot operation;
initializing a stack;
retrieving information corresponding to a most recently completed commissioning step for each commissioning step after a first commissioning step is completed; and
storing current information related to a current one of the commissioning steps into a non-volatile memory prior to the brown out reset.

5. The method as recited in claim 3 further comprising:
(a) booting up the device;(b) determining if the device is registered on the network;(c) responsive to the device not being registered on the network retrieving a last commissioning step performed by the device, if any commissioning steps have been performed;(d) performing a next step of the commissioning steps; (e) storing a commissioning state and commissioning parameters associated with the next step to non-volatile memory; and
repeating steps (a) through (e) until the commissioning is complete.

6. The method as recited in claim 4 wherein the information related to a current one of the commissioning steps includes a commissioning state and commissioning parameters.

7. The method as recited in claim 1 further comprising using a kinetic energy harvester to harvest the energy.

8. The method as recited in claim 1 further comprising between each of the commissioning steps entering a sleep mode.

9. The method as recited in claim 8 further comprising harvesting sufficient energy, at least part of which is harvested during the sleep mode, to have sufficient energy to power a next one of the commissioning steps prior to a next sleep mode.

10. The method as recited in claim 8 further comprising supplying power to random access memory during the sleep mode to maintain system state during the sleep mode to retain information related to the commissioning, including an indication of which commissioning steps have been completed.

11. The method as recited in claim 8 further comprising setting a sleep timer and awakening from the sleep mode when the sleep timer indicates the sleep mode is over.

12. An apparatus comprising:
an integrated circuit including a processor, a radio transceiver, and memory; and
wherein the processor is configured to cause a plurality of commissioning steps to be performed to accomplish a commissioning of a device on a radio frequency (RF) network, with each of the commissioning steps being performed between actuations of an energy harvesting operation.

13. The apparatus as recited in claim 12 wherein the integrated circuit enters a brown out reset in which the integrated circuit is deenergized after each of the commissioning steps.

14. The apparatus as recited in claim 13 wherein the memory includes non-volatile memory and wherein for each of the commissioning steps the processor is configured to perform a boot operation, a stack initialization, retrieval of commissioning information from the non-volatile memory if any, and saving current commissioning information to the non-volatile memory.

15. The apparatus as recited in claim 14 wherein the commissioning information includes commissioning state and commissioning parameters.

16. The apparatus as recited in claim 14 further comprising:
an energy harvester to harvest energy; and
an energy storage device to store the energy, the energy harvested after each brown out reset and prior to completion of commissioning being sufficient to perform the boot operation, the stack initialization, the retrieval of the commissioning information from the non-volatile memory, execution of one of the commissioning steps, and saving current commissioning information to the non-volatile memory.

17. The apparatus as recited in claim 12 wherein the memory includes random access memory (RAM) storing commissioning information and between each of the commissioning steps the integrated circuit is configured enter a sleep mode in which machine state is maintained in the RAM.

18. The apparatus recited in claim 12 wherein the apparatus is an energy constrained device.

19. The apparatus as recited in claim 12 further comprising an energy harvester and an energy storage device coupled to the energy harvester and to the integrated circuit.

20. An energy constrained device comprising:
an integrated circuit including a microcontroller and a radio frequency transceiver to communicate on a radio frequency (RF) network;
an energy harvesting device;
an energy storage device coupled to the energy harvesting device and configured to store energy harvested by the energy harvesting device and to supply power to the integrated circuit;
wherein the microcontroller is configured to cause a plurality of commissioning steps to be performed to accomplish a commissioning on the RF network to allow the energy constrained device to securely communicate on the RF network; and
wherein energy harvesting occurs between each of the commissioning steps to obtain sufficient energy to allow another commissioning step to be performed.
